(19) United States
(12) Patent Application Publication
(10) Pub. No.: US 2014/0251751 A1
(43) Pub. Date: Sep. 11, 2014

(54) FORK FOR CLUTCH AND MANUFACTURING METHOD THEREOF

(71) Applicant: Jaebong PARK, Seoul (KR)

(72) Inventor: Jaebong PARK, Seoul (KR)

(21) Appl. No.: 14/200,165

(22) Filed: Mar. 7, 2014

(30) Foreign Application Priority Data
Mar. 8, 2013 (KR) 10-2013-0025252

(51) Int. Cl. F16D 23/12; B22D 31/00

(52) U.S. Cl. CPC F16D 23/12; B22D 31/002
USPC 192/99 R; 164/69.1

(57) ABSTRACT

A fork for a clutch and a manufacturing method thereof are provided. The fork for a clutch may include C: 3.4˜3.9%, Si: 2.1˜2.5%, Mn: 0.2˜0.7%, P: 0.01% or less, S: 0.009˜0.02%, Cu: 0.2˜0.4%, and Mg: 0.04˜0.07% by weight ratio, with the remainder including iron (Fe) and other impurities. The material forming the fork for the clutch may have a structure in which spheroidal graphite is precipitated in an austenite matrix structure.

### CROSS-REFERENCE TO RELATED APPLICATION(S)

This application claims priority under 35 U.S.C. §119 to Korean Application No. 10-2013-0025252, filed in Korea on Mar. 8, 2013, whose entire disclosure is hereby incorporated by reference.

### BACKGROUND

1. Field

This relates to a fork for a clutch and a manufacturing method thereof, and more particularly, to a fork for a clutch used in a transmission of a vehicle, and a manufacturing method thereof.

2. Background

In general, a clutch of a manual transmission of a vehicle may transmit power by tightly attaching a clutch disk to a fly wheel using a pressure plate. Power may be cut off by releasing the clutch disk from the fly wheel so as to be converted into a transmission mode (or a shift mode). Thus, when a driver steps on the clutch (pedal) to change a speed, a force is transmitted to a fork to operate a clutch release bearing, thus releasing the clutch. Such a fork may have abrasion resistance to prevent abrasion due to frictional contact with a counterpart component and impact resistance tolerating impact transmitted when a speed is changed. Such a fork may be manufactured by forging high strength steel. However, manufacturing costs may be relatively high due to the multiple processes involve and material yield may be adversely impacted by the multiple processes.

### BRIEF DESCRIPTION OF THE DRAWINGS

The embodiments will be described in detail with reference to the following drawings in which like reference numerals refer to like elements wherein:

FIG. 1 illustrates an exemplary fork for a clutch.

FIG. 2 is a photograph of an internal structure of a fork, according to an exemplary embodiment as broadly described herein.

### DETAILED DESCRIPTION

Description will now be given in detail of exemplary embodiments, with reference to the accompanying drawings. For the sake of brief description with reference to the drawings, the same or equivalent components will be provided with the same reference numbers, and description thereof will not be repeated.

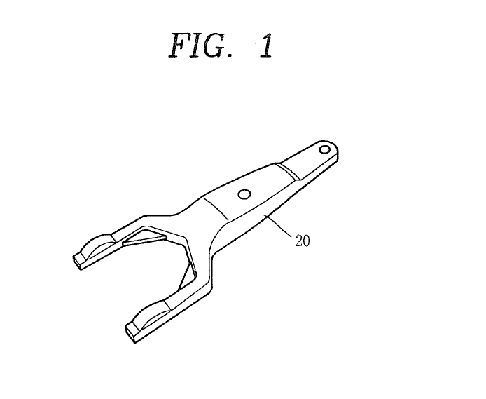

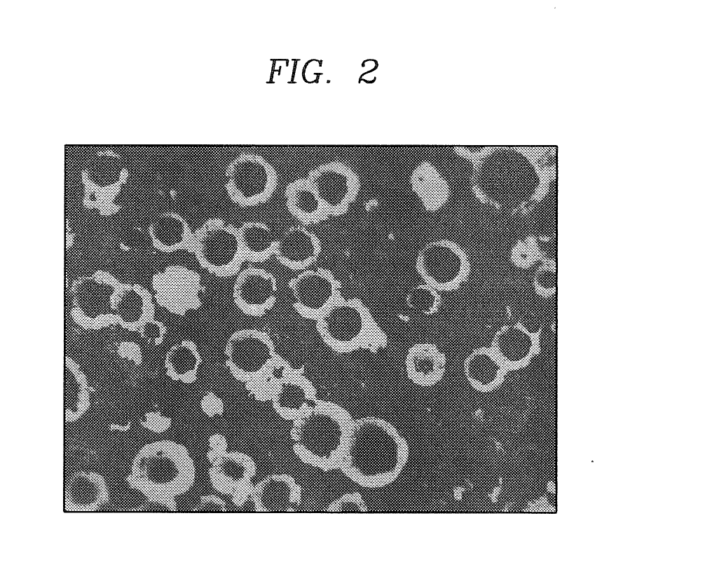

Hereinafter, a fork 20, according to an exemplary embodiment, as shown in FIG. 1, will be described in detail with reference to the accompanying drawings. Discussion will be directed to materials of the fork 20, as shown in FIG. 2, rather than to a configuration thereof, and thus, a fork as embodied and broadly described herein is not limited to a particular configuration.

In general, cast iron has relatively high hardness, abrasion resistance and machinability but has relatively low tensile strength and strong brittleness, so cast iron is rarely used as a material for components exposed to a high pressure atmosphere, such as, for example, in the case of a fork for a clutch, in which abrasion resistance, impact resistance, and fatigue resistance as described above are desired. In order to overcome shortcomings of cast iron, in the present exemplary embodiment, a nodular graphite cast iron having an austenite structure obtained by precipitating spheroidal graphite is utilized as a material of a fork.

Hereinafter, each element used to manufacture nodular graphite cast iron will be described. Unless otherwise mentioned, each content is expressed by a weight ratio.

### Carbon (C): 3.4˜4.0%

As a raw material of nodular graphite cast iron used to manufacture a fork for a clutch according, to an exemplary embodiment, the content of carbon (C) may be, for example, 3.4˜4.0% by weight ratio. In certain embodiments, the content of carbon (C) may be 3.6˜4.0%. In certain embodiments, the content of carbon (C) may be 3.6˜3.8%.

In cast iron, carbon (C) may exist as graphite or in the form of carbide represented by Fe3C. Thus, in a case in which the content of carbon is small, since most carbon exists in the form of carbide, a spheroidal graphite structure rarely appears, so the content of carbon (C) is added by an amount greater than or equal to 3.4% to obtain a uniform flake graphite structure. As the content of carbon (C) increases, a freezing point is lowered, improving castability, but a deposition amount of graphite may increase brittleness and negatively affect tensile strength. Namely, the highest tensile strength may be obtained when carbon saturation (Sc) ranges approximately from 0.8 to 0.9, and thus, a maximum limitation of the content of carbon (C) may be set to 4.0% to obtain good tensile strength.

### Silicon (Si): 1.5˜1.9%

As a raw material of nodular graphite cast iron used to manufacture a fork for a clutch, according to an exemplary embodiment, the content of silicon (Si) may be, for example, 1.5˜1.9% by weight ratio. In certain embodiments, the content of silicon (Si) may be 1.6˜1.9%. In certain embodiments, the content of carbon (C) may be 1.8˜1.9%. In certain embodiments, the content of carbon (C) may be 1.6˜1.8%.

Silicon (Si), a graphitizer, may decompose a carbide to precipitate graphite. Namely, addition of silicon (Si) may increase an amount of carbon. In addition, silicon (Si) may allow a micro-graphite structure existing in cast iron to grow as a flake graphite structure. The grown flake graphite structure is generated as spheroidal graphite by magnesium, a nodularizer, or the like. In particular, mechanical performance of a bainite matrix structure is increased according to an increase in the content of silicon. Namely, addition of a large amount of silicon (Si) may strengthen the bainite matrix structure to enhance tensile strength, and this is more conspicuous when the content of silicon is 3.0% or less. This is because, as the content of silicon is increased, a diameter of graphite is reduced and an amount of ferrite is increased to accelerate bainite transformation. The ferrite may include acicular ferrite structure.

Namely, when Si/C is increased, an amount of graphite is reduced and tensile strength may be enhanced as the matrix structure is strengthened due to high silicon. This may be remarkable when inoculation is performed on a molten metal.

However, if the content of silicon exceeds 3.0%, such an effect may be saturated. In addition, if the content of silicon is too high, the content of carbide is reduced to lower hardness and abrasion resistance, make it difficult for a material to be melted, and transform an austenite structure into a martenite structure during a follow-up cooling process to result in an increase in brittleness. In addition, as the content of silicon is increased, heat conductivity is lowered to make a temperature distribution non-uniform during cooling or heating to increase residual stress. Thus, the content of silicon is determined as 1.5˜1.9%.

Manganese (Mn): 0.5% or less

As a raw material of nodular graphite cast iron used to manufacture a fork for a clutch, according to an exemplary embodiment, the content of manganese (Mn) may be, for example, 0.5% or less by weight ratio. In certain embodiments, the content of manganese (Mn) may be 0.001˜0.5%. In certain embodiments, the content of manganese (Mn) may be 0.4% or less. In certain embodiments, the content of manganese (Mn) may be 0.3% or less. In certain embodiments, the content of manganese (Mn) may be 0.001˜0.3%. In certain embodiments, the content of manganese (Mn) may be 0.26% or less. Also, the content of manganese (Mn) may be 0.26˜0.5%.

Manganese (Mn), a white cast iron acceleration element hampering graphitizing of carbon, may stabilize combined carbon (namely, cementite). Manganese (Mn) may also hinder precipitation of ferrite and refine pearlite, so it may be advantageous to make a matrix structure of cast iron pearlite. In particular, manganese (Mn) may be combined with sulfur of cast iron to create mangan sulfide. Mangan sulfide may float to a surface of a molten metal so as to be removed as slag, or may remain in cast iron as a non-metallic inclusion to prevent generation of iron sulfide. Namely, manganese (Mn) may neutralize harm of sulfur. In order to accelerate pearlite and remove a sulfur component, the content of manganese (Mn) may be contained in an amount of, for example, 0.5% or less.

Phosphor (P): 0.05% or less

As a raw material of nodular graphite cast iron used to manufacture a fork for a clutch, according to an exemplary embodiment, the content of phosphor (P) may be, for example, 0.05% or less by weight ratio. In certain embodiments, the content of phosphor (P) may be 0.008˜0.05%. In certain embodiments, the content of phosphor (P) may be 0.01˜0.05%. In certain embodiments, the content of phosphor (P) may be 0.008-0.01%.

Phosphor (P) forms a compound of iron phosphide (Fe3P) and exists as a ternary eutectic steadite together with an iron carbide. The iron phosphide may be easily undercooled and easily cause segregation in casting. Thus, as the content of phosphor (P) is increased, brittleness is increased and tensile strength is rapidly degraded. Thus, the content of phosphor (P) may be 0.05% or less.

### Sulfur (S): 0.009˜0.02%

As a raw material of nodular graphite cast iron used to manufacture a fork for a clutch, according to an exemplary embodiment, the content of sulfur (S) may be, for example, 00.009˜0.02% by weight ratio. In certain embodiments, the content of sulfur (S) may be 0.01˜0.02%. In certain embodiments, the content of sulfur (S) may be 0.013˜0.02%.

Addition of a relatively large amount of sulfur (S) may degrade fluidity of a molten metal, may increase shrinkage, and may cause a shrinkage cavity or cracks. Thus, sulfur (S) may be contained in as small an amount as possible. Thus, sulfur (S) may be managed to be within the content.

### Copper (Cu) 0.2˜0.4%

As a raw material of nodular graphite cast iron used to manufacture a fork for a clutch, according to an exemplary embodiment, the content of copper (Cu) may be, for example, 0.2˜0.4% by weight ratio. In certain embodiments, the content of copper (Cu) may be 0.25˜0.4%. In certain embodiments, the content of copper (Cu) may be 0.3˜0.4%.

Copper (Cu) may thicken and shorten a shape of graphite, reduce D and E-type undercooled graphite, and accelerate A-type flake graphite. Also, copper (Cu) may improve a form of graphite, hamper graphitizing and reduce chilled tendency during a eutectoiding process. In addition, copper (Cu) may improve a distribution of carbide, form pearlite, and sub-divide the structure.

In addition, while accelerating formation of pearlite, copper (Cu) may reduce a distance between pearlites to subdivide the pearlite. Also, copper (Cu) may increase fluidity of a molten metal, enhance castability and thus lower residual stress. In addition, copper (Cu) may make the structure more dense and slightly enhance tensile strength, hardness, or the like, of cast iron. To this end, copper may be added by the foregoing content.

### Pig Iron

As a raw material of nodular graphite cast iron used to manufacture a fork for a clutch, according to an exemplary embodiment, pig iron may be used. Pig iron Pig iron, a type of iron immediately produced from iron ore, may contain impurities such as sulfur, phosphor, manganese, and the like, besides carbon (C). Due to brittleness, pig iron is not typically rolled or forged. However, since pig iron has a low melting point, pig iron may be appropriate to be utilized as a raw material of casting.

Scraps, namely, fragments or the like, produced while steel is mechanically processed has characteristics the same as or similar to those of the base material. In addition, steel waste remaining after steel is utilized at, for example, construction sites or various structures may retain ductility and toughness of the original steel. Thus, steel waste may be mixed with pig iron during a casing process to improve characteristics of pig iron.

Hereinafter, a manufacturing process for manufacturing a fork, according to an exemplary embodiment, will now be described.

### (1) Smelting

The foregoing elements may be selected in appropriate ratios to prepare a raw material, and the raw material may be put into a middle frequency induction furnace and heated to be melted, and subsequently smelted. The crude liquid molten metal may be taken out at a temperature ranging from approximately 1490° C. to 1530° C.

### (2) Spheroidization and Inoculation

A nodularizer for nodularizing graphite and an inoculant may be inoculated to the crude liquid molten metal smelted in the smelting process. In this case, magnesium (Mg), calcium (Ca), and rare earth resources (RE), known to accelerate nodularization of graphite, may be used as the nodularizer. In detail, a nodularizer having components such as Mg: 5.5-6.5%, Si: 44-48%, Ca: 0.5-2.5%, AL<1.5%, RE: 0.8-1.5%, MgO<0.7% may be used. For example, FeSiMg6RE1 may be added in an amount of 1.0˜1.2% of the mass of the crude liquid molten metal.

Inoculation may generates a large amount of graphite nucleus to accelerate graphitizing, and may uniformly distribute graphite, and may increase strength. As an inoculant, a barium silicon iron alloy (FeSi72Ba2) may be used and the content of inoculant is 0.1˜0.2% of the mass of the crude liquid molten metal.

When spheroidization and inoculation are performed, components in the molten metal may include C: 3.4˜3.9%, Si: 2.1˜2.5%, Mn: 0.2˜0.7%, P: 0.01% or less, S: 0.05% or less, Cu: 0.2˜0.4%, and Mg: 0.04˜0.07% by weight ratio, and Fe comprising the remainder.

### (3) Casting

The inoculated molten metal may be injected into a mold manufactured in advance to have a cavity having a desired shape. Casting may be performed using, for example, a green sand mold, and a temperature of the molten metal during the injection process is controlled to range from 1390˜1420° C. The molten metal after spheroidization should be injected into a mold within, for example, 10 minutes. When the molten metal injected into the mold is cooled, a fork formed of globular cast iron containing spheroidal graphite, ferrite, and pearlite is obtained.

### (4) Machining

The fork semi-product obtained in the casting process may be first cleaned to remove sand and an oxide layer attached to a surface thereof, and then machined to have an intended shape.

### (5) Isothermal Hardening

Isothermal hardening (heat treatment process) may be performed on the machined fork to austenitize the matrix structure. In detail, the machined fork semi-product having a pearlite matrix structure may be heated using an electrical resistance furnace capable of controlling an air temperature to reach 890˜930° C., maintained for 1.5 to 2.5 hours, and put into a nitrate solution having a temperature ranging from 340˜360° C. and maintained for 1˜2 hours, taken out, and cooled to reach room temperature in the air. Through this heat treatment, the pearlite matrix of the fork semi-product may be transformed into an austenite matrix structure, and thus, toughness and impact resistance may be significantly enhanced.

A solution in which KNO3 and NaNO3 are mixed in a weight ratio of 1:1 may be used as the nitrate solution. There is no particular limitation in concentration of the nitrate solution and concentration of KNO3 and NaNO3 forming the nitrate solution. The nitrate solution, as a quenching medium, may be advantageous, compared with general quenching oil.

When applying the nitrate solution as described above, there is no steam membrane process during a nitrate solution quenching process, and a high temperature section cooling speed is relatively high, and thus, a quenching structure having excellent thick part may be obtained. The nitrate solution has a cooling speed close to 0 in the case of low temperature section isothermal, and thus, quenching strain is very low. A cooling speed of nitrate may be adjusted by adjusting the content of water (which is between fourfold of hot oil cooling speed and oil cooling speed. A surface of a part has a stress pressure state, and crack of the part is reduced, and a lifespan of the part is lengthened. After quenching, the part has uniform metal gloss and navy color, and after cleaning, it is not required to perform channeling or peening, and corrosion-resistance performance is high.

When isothermal hardening is finished, the fork may have tensile strength of, for example, 1100 MPa or higher and Rockwell hardness (HRc) of, for example, 50˜55.

### (6) Fine Grinding and Polishing

The fork of the nodular graphite cast iron of carbide obtained through the heat treatment may be fine-ground and polished to have a final shape and required surface quality.

Hereinafter, embodiments of the fork for a clutch, according to various embodiments, will be described.

In one embodiment, C: 3.8%, Si: 1.5%, Mn: 0.3%, P: 0.01%, S: 0.01%, and Cu: 0.2% by weight ratio and Fe comprising the remainder may be mixed by weight ratio and put into a middle frequency induction furnace, and smelted to obtain a crude liquid (crude liquid molten metal) of nodular graphite cast iron, and then taken out of the furnace at a temperature, for example, of 1500° C. The crude liquid molten metal of nodular graphite cast iron taken out of the furnace may be spheroidized and inoculated, and, in certain embodiments, rare earth resource silicon iron magnesium alloy (FeSiMg6RE1) added as a nodularizer in an amount of 1.1% of the mass of the crude liquid molten metal, and barium silicon iron (FeSi72Ba2) added as an inoculant in an amount of 0.15% of the mass of the crude liquid molten metal. As a result, components (wt %) of the molten metal may be C: 3.8, Si: 2.3, Mn: 0.3, P: 0.01, S: 0.01, Cu: 0.2, and Mg: 0.04.

The spheroidized and inoculated molten metal may be injected into a green sand mold manufactured in advance. A temperature of the molten metal may be, for example, 1398° C. and the spheroidized and inoculated crude liquid may be injected for 7 minutes. The crude liquid may be cooled to obtain a nodular cast iron fork containing spheroidal graphite, ferrite, and pearlite.

Thereafter, the nodular cast iron fork may be processed to have a fork shape, heated to reach 890° C. using a furnace capable of continuously heating, maintained for 2 hours, and quickly put into a nitrate solution having a temperature of 340° C. for 1.5 hours. Thereafter, the nodular cast iron fork may be taken out and cooled to reach room temperature to obtain austenite nodular graphite cast iron fork.

Finally, fine grinding and polishing may be performed to allow the fork to have required surface roughness.

In certain embodiments, C: 3.6%, Si: 1.6%, Mn: 0.26%, P: 0.008%, S: 0.01%, and Cu: 0.2%, and Fe comprising the remainder may be mixed and melted, drawn out at a temperature of 1510° C., to which 1.1% of FeSiMg6RE1 of the mass of the crude liquid molten metal and 0.15% of FeSi72Ba2 of the mass of the crude liquid molten metal may be applied. Components (wt %) of the spheroidized molten may be C: 3.6, Si: 2.3, Mn: 0.3, P: 0.008, S: 0.012, Cu: 0.3, and Mg: 0.045.

Thereafter, the molten metal may be injected to a green sand mold at a temperature of 1403° C. for 8 minutes and subsequently cooled. The obtained fork semi-product may be machined and isothermally-hardened. The fork semi-product may heated to reach 910° C., maintained for 2 hours, and put into a nitrate solution having a temperature of 350° C. for 1.5 hours. Thereafter, the fork semi-product may be cooled to reach room temperature and fine-ground and polished.

In still another embodiment, C: 3.4%, Si: 1.8%, Mn: 0.3%, P: 0.01%, S: 0.013%, and Cu: 0.25%, and Fe comprising the remainder may be mixed and melted, drawn out at a temperature of 1515° C., to which 1.1% of FeSiMg6RE1 of the mass of the crude liquid molten metal and 0.15% of FeSi72Ba2 of the mass of the crude liquid molten metal may be applied. Components (wt %) of the spheroidized molten may be C: 3.4, Si: 2.35, Mn: 0.3, P: 0.01, S: 0.013, Cu: 0.25, and Mg: 0.04.

Thereafter, the molten metal may be injected into a green sand mold at a temperature of 1410° C. for 8 minutes and subsequently cooled. The obtained fork semi-product may be machined and isothermally-hardened. The fork semi-product was heated to reach 920° C., maintained for 2 hours, and put into a nitrate solution having a temperature of 350° C. for 1.5 hours. Thereafter, the fork semi-product may be cooled to reach room temperature and fine-ground and polished.

FIG. 2 is a photograph of an internal structure of the first embodiment described above, which is comprised of austenite and spheroidal graphite.

A fork for a clutch and a manufacturing method thereof, as embodied and broadly described herein, may be relatively easily manufactured at relatively low

A fork for a clutch, as embodied and broadly described herein, may include C: 3.4˜3.9%, Si: 2.1˜2.5%, Mn: 0.2˜0.7%, P: 0.01% or less, S: 0.009˜0.02%, Cu: 0.2˜0.4%, and Mg: 0.04˜0.07% by weight ratio and iron (Fe) and any inevitable impurity comprising the remainder, and have a structure in which spheroidal graphite is precipitated in an austenite matrix structure.

Since the fork is manufactured using nodular graphite cast iron having the foregoing components and structure, the fork may have sufficient strength and abrasion resistance, while reducing a manufacturing cost and time, compared to forging. Accordingly, the fork may be easily manufactured at low costs.

Various components may be adjusted to fall within the above range by using scrap, pig iron, steel waste, and the like. Scrap may refer to fragments, or the like, produced during mechanical working, and steel waste may refer to steel discarded after being used. Since scrap and steel waste are low in price and easily obtained, manufacturing costs may be further reduced.

A structure may include acicular ferrite structure.

A method for manufacturing a clutch for a fork, as embodied and broadly described herein, may include mixing raw materials including C: 3.4˜4.0%, Si: 1.5˜1.9%, Mn: 0.5% or less, P: 0.05% or less, S: 0.009˜0.02%, and Cu: 0.2˜0.4%, by weight ratio and iron (Fe) comprising the remainder and smelting the crude liquid molten metal; applying a nodularizer and an inoculant to the smelted crude liquid molten metal to obtain a molten metal; injecting the molten metal into a mold to obtain a fork semi-product; machining the fork semi-product to have a predetermined shape; and isothermally hardening the machined fork semi-product.

During the operation of smelting the crude liquid molten metal, the crude liquid molten metal may be taken out at a temperature of 1490˜1530° C.

A rare earth source silicon iron magnesium alloy (FeSiMg6RE1) may be applied as the nodularizer in an amount of 1.0˜1.1% of the mass of the crude liquid molten metal.

The isothermally hardening may include heating the fork semi-product to reach a temperature of 890˜930° C. and maintaining the heated fork semi-product for 1.5˜2.5 hours; putting the fork semi-product into a liquid having a temperature of 340˜360° C. and maintaining the fork semi-product in the liquid for 1˜2 hours; and cooling the fork semi-product to reach room temperature in the air.

The liquid may be a nitrate solution generated by mixing KNO3 and NaNO3 in a mass ratio of 1:1.

Components of the molten metal with the nodularizer and the inoculant injected therein may include C: 3.4˜3.9%, Si: 2.1˜2.5%, Mn: 0.2˜0.7%, P: 0.01% or less, S: 0.05% or less, Cu: 0.2˜0.4%, and Mg: 0.04˜0.07% by weight ratio, and Fe comprising the remainder.

The method may further include grinding the hardened fork semi-product to have a final shape.

Since a fork is manufactured using nodular graphite cast iron having the foregoing characteristics, a manufacturing process and time may be shortened, while the fork has sufficient strength and abrasion resistance, compared to forging. Thus, the fork may be easily manufactured at low cost.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A fork for a clutch, a material of the fork comprising C: 3.4˜3.9%, Si: 2.1˜2.5%, Mn: 0.2˜0.7%, P: 0.01% or less, S: 0.009˜0.02%, Cu 0.2˜0.4%, and Mg: 0.04˜0.07% by weight ratio, and iron (Fe) comprising a remainder, the material having a structure in which spheroidal graphite is precipitated in an austenite matrix structure.

2. The fork of claim 1, wherein the structure comprises an acicular ferrite structure.

3. A method for manufacturing a fork for a clutch, the method comprising:
mixing raw materials including C: 3.4˜4.0%, Si: 1.5˜1.9%, Mn: 0.5% or less, P: 0.05% or less, S: 0.009˜0.02%, and Cu: 0.2˜0.4%, by weight ratio, and iron (Fe) comprising a remainder, and smelting a resulting crude liquid molten metal;
applying a nodularizer and an inoculant to the smelted crude liquid molten metal;
injecting the molten metal into a mold to obtain a fork semi-product;
machining the fork-semi-product to have a predetermined shape; and
isothermally hardening the machined fork semi-product.

4. The method of claim 3, wherein smelting the crude liquid molten metal comprises removing the crude liquid molten metal out of a furnace when the liquid molten metal reachesla temperature of 1490˜1530° C.

5. The method of claim 3, wherein applying a nodularizer and an inoculant to the smelted crude liquid molten metal comprises applying a rare earth source silicon iron magnesium alloy (FeSiMg6RE1) as the nodularizer in an amount of 1.0˜1.1% of a mass of the crude liquid molten metal.

6. The method of claim 3, wherein isothermally hardening the machined fork semi-product comprises:
heating the fork semi-product to a first temperature of 890˜930° C. and maintaining the heated fork semi-product at the first temperature for 1.5˜2.5 hours;
putting the fork semi-product into a liquid having a second temperature of 340˜360° C. and maintaining the fork semi-product in the liquid at the second temperature for 1˜2 hours; and
cooling the fork semi-product to as third temperature corresponding to a room temperature.

7. The method of claim 6, wherein putting the fork semi-product into a liquid having a second temperature comprises putting the fork semi-product into a nitrate solution generated by mixing KNO₃ and NaNO₃ in a mass ratio of 1:1.

8. The method of claim 5, wherein components of the molten metal having the nodularizer and the inoculant injected therein comprise C: 3.4˜3.9%, Si: 2.1˜2.5%, Mn: 0.2˜0.7%, P: 0.01% or less, S: 0.05% or less, Cu: 0.2˜0.4%, and Mg: 0.04˜0.07% by weight ratio, and Fe comprising the remainder.

9. The method of claim 3, further comprising:
grinding the isothermally hardened fork semi-product to a final shape.
